(19) United States
(12) Patent Application Publication
(10) Pub. No.: US 2008/0300870 A1
(43) Pub. Date: Dec. 4, 2008

(54) Method and Module for Improving Personal Speech Recognition Capability

(75) Inventors: Chih-Wen Hsu, Hsin-Tien City (TW); Hung-Zhong Gao, Hsin-Tien City (TW); Chin-Jung Liu, Hsin-Tien City (TW); Tai-Hsuan Ho, Hsin-Tien City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: CYBERON CORPORATION, Hsin-Tien City (TW)

(21) Appl. No.: 11/874,469

(22) Filed: Oct. 18, 2007

(30) Foreign Application Priority Data
May 31, 2007 (TW) 096119527

(51) Int. Cl. G10L 15/22

(52) U.S. Cl. 704/231; 704/E15.04

(57) ABSTRACT

A method and a module for improving personal speech recognition capability for use in a portable electronic device are provided. The portable electronic device has a predetermined recognition model constructed of a phoneme model for recognizing at least a command speech from a user. The method comprises the steps of: establishing a database having specific characters which are related to the command speech; construing an adaptation parameter by retrieving a plurality of speech datum spoken by the user according to the database; and modulating the recognition model by integrating the phoneme model and the adaptation parameter. The user can effectively adapt the recognition model to improve the recognition capability according to the above steps.

This application claims priority based on Taiwan Patent Application No. 096119527 filed on May 31, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a method and a module for improving personal speech recognition capability, and more particularly, relates to a module for improving personal speech recognition capability for use in a portable electronic device and a method thereof.

2. Descriptions of the Related Art

With the advent of the digital times, interaction between people and various portable electronic products are becoming more and more frequent. Under such a circumstance, control interfaces of the portable electronic products nowadays are becoming increasingly inadequate to satisfy user's requirements. As language is the most common way for people to communicate with each other, if the user is allowed to issue a command to the portable electronic products with language speeches directly, control interfaces of such products will be more acceptable due to the improved operational convenience, and the added value of the products will be increased significantly.

For example, a handset with a speech recognition capability usually has a pre-determined recognition model constructed of at least one phoneme model, according to which the handset can recognize at least a command speech from a user. The pre-determined recognition model is irrelative to the user, that is, the user can enjoy the convenience of speech recognition without need to record his or her speech in advance. Unfortunately, such a recognition model cannot take speech difference among different individuals into consideration, so that the recognition capability will degrade when there exists a great difference between a user's speech and the pre-determined recognition model.

The Hidden Markov Model (HMM) is a speech model commonly used in the speech recognition field to construct a phoneme model. The HMM speech model interprets each input datum (e.g., a speech) as a probability generation model. The HMM speech model has a probability distribution for each index (e.g., each word or each phrase), so that what a speech is can be determined by checking a matching probability of each index in this speech. To make the speech recognition more accurate, the HMM speech model needs to be adapted using speech data, so that it can recognize speech signals from different users by such an adaptation.

On the other hand, each speech spoken by a user consists of various phonemes. For example, pronunciation of each Chinese word comprises of a different initial syllable or a different final syllable. In this case, each different initial syllable or final syllable can be considered as a different phoneme. A phoneme model is a model constructed for each different phoneme on basis of the HMM speech model.

In order to issue a command directly with a speech, a conventional command speech recognition method establishes a recognition model for each command with phoneme models. For example, in the speech “place a call to Wang Xiaoming”, “place a call to” can be considered as a command. Because each individual has a different tone, a user has to input his corresponding speech data to adapt his command speech recognition model for various commands. However, this adjustment is a progressive process so that the user has to provide the speech of “place a call to” repeatedly until the corresponding command recognition model can recognize this command of the user.

These methods described above for improving personal speech recognition capability all require the user to adjust different command recognition models one by one, and the user may also have to input a single speech datum several times for a same command recognition model, which is quite inconvenient and inefficient for the user.

In summary, efforts still have to be made by manufacturers to find a way for improving efficiency of adapting a command speech recognition model without need to adjust different command speech recognition models one by one, thereby to save time and improve the personal speech recognition capability.

### SUMMARY OF THE INVENTION

One objective of this invention is to provide a method for improving personal speech recognition capability in a portable electronic device. This method can group various phoneme models related to speech data according to a pre-determined rule, and then each time when a user provides a speech datum, corresponding phoneme models will be adapted, during which process a command speech recognition model comprising the phoneme models is also adapted. In this way, this invention can improve the shortcoming that corresponding speech data have to be input by the user for various command speech recognition models in the conventional command speech recognition method. To this end, in a method disclosed in this invention, an adaptation parameter is generated by retrieving a plurality of speech data spoken by the user; and then the recognition model is modulated by integrating at least one phoneme model and the adaptation parameter. With these above steps, the recognition model in the portable electronic device can be adapted.

Another objective of this invention is to provide a module for improving personal speech recognition capability in a portable electronic device. This module implements the method described above to improve the shortcoming that corresponding speech data have to be input by the user for various command speech recognition models in the conventional command speech recognition method. To this end, the module disclosed in this invention comprises a recognition model, an adaptation parameter model, and an integration module, wherein the recognition model comprises phoneme models, the adaptation parameter model is constructed by speech data provided by the user, and the integration module is configured to modulate the recognition model by integrating the phoneme models and the adaptation parameter. In this way, this invention can utilize the modulation technology to improve the recognition capability of the recognition model to recognize speech of a specific user.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a flow diagram of an embodiment of a method in accordance with this invention;

FIG. 2 is a more detailed flow diagram of an embodiment of the method in accordance with this invention;

FIG. 3 is a schematic view of a group construction of phoneme models in accordance with this invention; and

FIG. 4 is a schematic diagram of an embodiment of a module in accordance with this invention.

### DESCRIPTION OF THE PREFERRED EMBODIMENT

A preferred embodiment of this invention is a method for improving personal speech recognition capability in a portable electronic device provided with speech recognition capability. In this embodiment, the portable electronic device is a handset having a recognition system. The recognition system comprises a pre-determined recognition model constructed of at least one phoneme model. This method modulates the recognition model by integrating the at least one phoneme model and an adaptation parameter, after which the handset can utilize the modulated recognition module to improve its capability to recognize at least one command speech spoken by a user. More specifically, the unmodulated pre-determined recognition model recognizes speeches from different users with a same recognition model, and therefore can be considered to be constructed by a non-specific phoneme model.

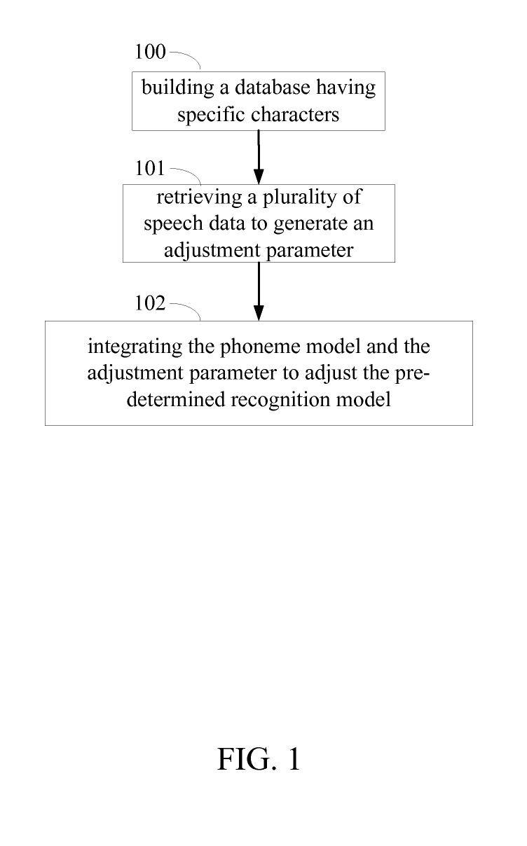

Referring to FIG. 1, this method begins with step 100, in which a database having specific characters is established. In this preferred embodiment, the database having specific characters is related to characters corresponding to the command speeches the user can use, and is not necessarily the same as the command speeches. For example, command speeches pre-determined in the handset to operate the handset comprise “place a call to”, “power off”, and so on, and the database having specific characters is established according to features of these command speeches in order to improve speech recognition capability of the handset for a specific user. Therefore, the database can be constructed either of these command speeches or of other characters related to the speech features of these commands. As to the speech features, a further description will be made hereinafter.

Next in step 101, when the user speaks a command speech according to the aforementioned database, an adaptation parameter is generated by retrieving features of a plurality of speech data spoken by the user. Finally in step 102, the recognition model is modulated by integrating the at least one phoneme model and the adaptation parameter.

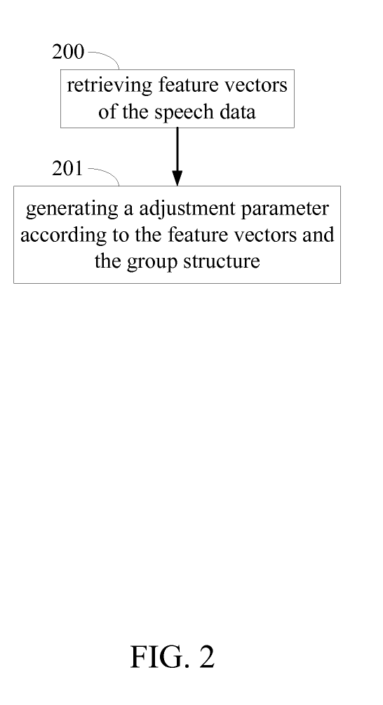

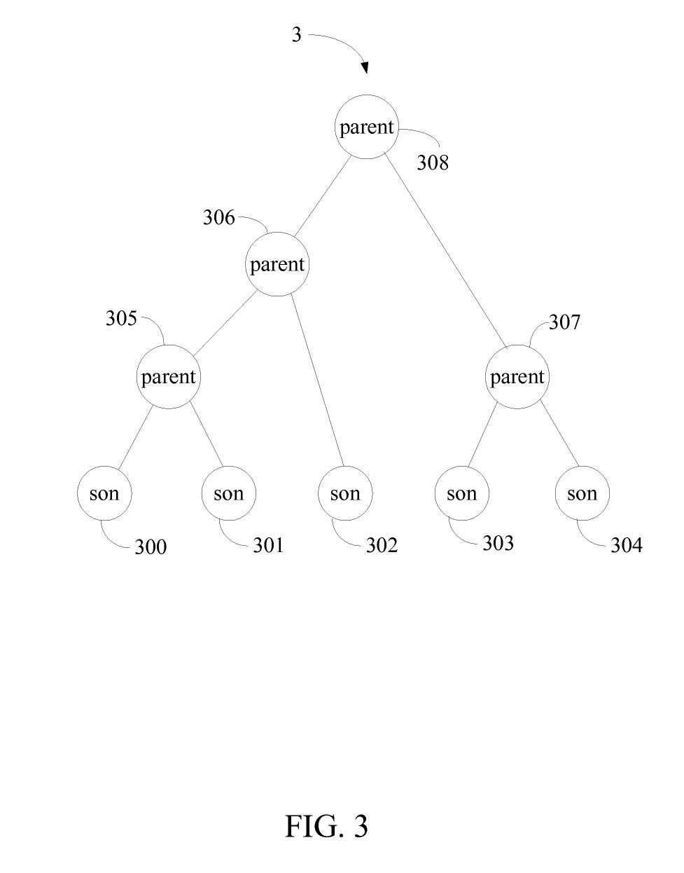

Referring to FIG. 2, the following sub-steps of step 110 are depicted in detail: feature vectors are retrieved from a plurality of speech data in step 200, wherein the feature vectors can be one of a Mel-Scale Frequency Cepstrum Coefficient, a Linear Predictive Cepstrum Coefficient, and a Cepstrum, or a combination thereof. Next in step 201, an adaptation parameter is generated according to the retrieved feature vectors and a group structure of a phoneme model. The group structure is established according to the pre-determined phoneme model and is irrelevant to a language tendency of the user. A further description of the group construction will be made hereinafter with reference to FIG. 3.

More specifically, in step 201, subsequent to speech data retrieval, the recognition system retrieves the feature vectors of the speech data, which are related to personal speaking habits of the user. Then the recognition system utilizes these feature vectors and a group construction of phoneme models to generate an adaptation parameter. For example, a combination of approaches, such as a maximum a posteriori estimation (MAP) algorithm, a maximum likelihood linear regression (MLLR) algorithm, and a vector-field smoothing (VFS) algorithm, can be employed to achieve an optimum modulation effect under various training speech data. The MLLR and the VFS algorithms employ a grouping approach to overcome the problem of insufficient modulating data in the probability distribution models, so that when data in a certain probability distribution model (e.g., an HMM speech model) is insufficient, reference can be made to other specifically related probability distribution models within the same sub-group to adapt the probability distribution model. The specific relation among various probability distribution models is represented by a group construction. In case data in the sub-group is still insufficient or in shortage, the sub-groups will be constructed into a tree structure, so that when data in a certain sub-group is insufficient, the recognition system can trace upstream along the tree structure and incorporate the data with data of another sub-group. In case the incorporated data is still insufficient, the tracing process will proceed upstream until sufficient data is available in a group for modulating the recognition model.

Refer to FIG. 3, which depicts a schematic view of a group construction 3. The grouping operation is performed according to a well-known k-means algorithm, which divides phoneme models of the speech data into five sub-groups 300, 301, 302, 303, and 304, and this will not be further described herein. Then relationships among different sub-groups are enhanced in a bottom-up way, so that sufficient data will be available in a group for modulating the recognition model. These sub-groups are combined further into parent groups 305, 306, 307 and 308 according to their similarities (i.e., distance or maximum similarities). The combination process will proceed upstream to finally form a tree structure to complete the group construction. This method can be adjusted depending on actual conditions, and is not intended to limit the scope of this invention.

More specifically, provided that a user speaks “B” and “P” in a quite similar pronunciation due to his phonetic accent (i.e., language tendency), the models for “B” and “P” can be considered as two phoneme models having a specific relation within the same sub-group 300. Then as long as the retrieved feature vectors comprise feature vectors related to “B” and “P”, these related feature vectors will also be used to modulate phoneme models within the same group.

Thus in this embodiment, the pre-determined recognition models can be adapted by integrating the adaptation parameters and the phoneme models according to the group construction described above. Since the adaptation parameters have already been grouped according to the accent of the user in this preferred embodiment, as long as the pre-determined recognition model comprises recognition models of the commands “power off” and “place a call” and the speech of the user includes “B” and “P”, the phoneme models for “B” and “P” will be adapted, during which process the “power off” and “place a call” command recognition models comprising theses phoneme models will also be adapted together. In other words, all recognition models comprising a same phoneme model will be jointly adapted, and the adapted recognition models are considered to be constructed of specific phoneme models.

It can be understood from the above description that this invention can adapt recognition models using only a small amount of speech data. In other words, by use of a group construction of phoneme models, when a user speaks a certain speech, phoneme models related to this speech will be also adapted, thereby to adapt the command recognition model. In this way, the user can adapt all recognition models using only a small amount of speech data.

Another preferred embodiment of this invention is a module 4 for improving personal speech recognition capability in a portable electronic device (e.g., a handset). The module 4 comprises a recognition model 400, an adaptation parameter model 401 and an integration module 402, and can adopt the method described in the above preferred embodiment to improve speech recognition capability.

The recognition model 400 is constructed of a phoneme model and is used to recognize a command speech spoken by a user. The phoneme model is just as described in the above preferred embodiment, and will not be further described herein. The adaptation parameter model 401 is constructed according to the speech data of the user, and comprises a group construction described in the above preferred embodiment. The group construction, formed according to specific relations among various phoneme models, is just as described in the above preferred embodiment, and will not be further described herein. The adaptation parameter model 401 is generated by retrieving feature vectors of a plurality of speech data spoken by the user and the group construction, wherein the plurality of speech data are spoken by the user according to a database having specific characters. The database is designed with a goal to allow the user to speak a speech related to the phoneme models constructing the command speech. For example, the specific characters can be a command such as “place a call” or “power off”, or a specific phrase such as “you have a coming call in the room” or “a great weather”. For the same characters, different users may have different pronunciation. The integration module 402 is configured to integrate the phoneme model and the adaptation parameter model to modulate the recognition model. The modulating manner is just as described in the above preferred embodiment, and will not be further described herein.

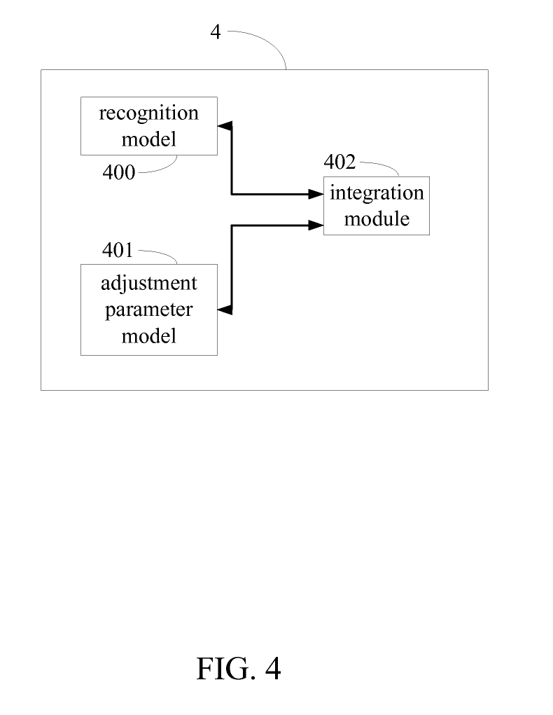

In addition to the operation and functions depicted in FIG. 4, the module 4 can also perform all steps of the method described in the above preferred embodiment. The way in which the module 4 performs these steps will be apparent to those of ordinary skill in the art, and will not be further described herein.

It follows from the above description that, this invention can generate a group construction by grouping various phoneme models, and then modulate the phoneme models by use of an adaptation parameter related to the user based on this group construction. In this way, the recognition model can also be modulated. Hence, this invention can modulate the recognition model using only a small amount of speech data, thereby to improve the personal speech recognition capability. This represents an improvement over the conventional command recognition method.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for improving personal speech recognition capability for use in a portable electronic device, the portable electronic device storing a pre-determined recognition model constructed of at least one phoneme model for recognizing at least a command speech from a user, the method comprising the steps of:
establishing a database having specific characters which are related to characters of the command speech;
generating an adaptation parameter by retrieving a plurality of speech data spoken by the user according to the database; and
modulating the recognition model by integrating the at least one phoneme model and the adaptation parameter.

2. The method of claim 1, wherein the step of generating an adaptation parameter is to retrieve feature vectors of the speech data and to construe a group construction in connection with the at least one phoneme model.

3. The method of claim 2, wherein the step of generating an adaptation parameter is to construe the group construction according to relation-specific speeches.

4. The method of claim 2, wherein the step of modulating the recognition model is to integrate the at least one phoneme model and the adaptation parameter according to the group construction.

5. The method of claim 1, wherein the recognition model is created according to at least one unspecified phoneme model.

6. A module for improving personal speech recognition capability for use in a portable electronic device, comprising:
a recognition model preloaded in the portable electronic device, in which the recognition model is created according to at least one phoneme model, and the recognition model is adapted to recognize at least one command speech spoken by a user;
an adaptation parameter model comprising a group construction irrelative to a language tendentiousness of the user; and
an integration module being adapted to modulate the recognition model by integrating the at least one phoneme model and the adaptation parameter.

7. The module of claim 6, wherein the group construction is constructed according to specific relation of the at least one phoneme model.

8. The module of claim 6, wherein the recognition model is created according to at least one unspecified phoneme model.
